(19) United States
(12) Patent Application Publication
(10) Pub. No.: US 2011/0073551 A1
(43) Pub. Date: Mar. 31, 2011

(54) FILTER MODULES FOR IMPROVED MEDIA UTILIZATION AND USE IN GENERALLY CYLINDRICAL HOUSING

(75) Inventors: ROGER P. REID, CALDWELL, ID (US); BRUCE D. SAASKI, NAMPA, ID (US)

(73) Assignee: OMNIPURE FILTER COMPANY, INC., CALDWELL, ID (US)

(21) Appl. No.: 12/748,372

(22) Filed: Mar. 26, 2010

Related U.S. Application Data
(63) Continuation-in-part of application No. 11/858,765, filed on Sep. 20, 2007.
Application No. 11/858,765 is a continuation-in-part of application No. 29/334,388, filed on Mar. 25, 2009, now Pat. No. D615150.
Application No. 29/334,388 is a continuation-in-part of application No. 29/334,390, filed on Mar. 25, 2009, now Pat. No. D617869.
(60) Provisional application No. 61/163,768, filed on Mar. 26, 2009.
(60) Provisional application No. 60/846,162, filed on Sep. 20, 2006.

(51) Int. Cl. B01D 29/52

(52) U.S. Cl. 210/800; 210/323.1

(57) ABSTRACT

Filter modules for use in a water dispenser, carafe, or other gravity-flow water filtration and dispensing unit are self-supporting, rigid and porous, and are adapted in size and shape to substantially fill a generally-cylindrical housing. The filter modules are molded forms of high-porosity compositions, so that they are consistent in performance and “non-dusting” compared to the unpredictable arrangements, positions, and performance of loose activated carbon particles. Filter modules may include activated carbon, zeolitic, resins, metal-scavengers, and/or other water filtration/treatment media granules/powders, for example, bound into a solid profile form by thermoplastic and/or other polymeric binders. Low melt index, or very low melt index, binders are preferred to maximize exposure of the activated carbon surface area. Thin walls of media surround the preferred single core/bore of each module, to preferably form generally D-shaped or triangular modules, wherein multiple modules of the same shape may be attached side-by-side to a housing plate/member, to substantially fill the housing, with the modules close together but spaced to allow water flow between and all around the modules.

This application claims benefit of Provisional Application Ser. No. 61/163,768, filed Mar. 26, 2009; and this application is a continuation-in-part of Ser. No. 11/858,765, filed Sep. 20, 2007, which claims priority of Provisional Application Ser. No. 60/846,162, filed Sep. 20, 2006. This application also claims priority of U.S. Serial Number 29/334,388, filed Mar. 25, 2009, and U.S. Serial Number 29/334,390, filed Mar. 25, 2009. The entire disclosures of the above-listed provisional, non-provisional, and design applications are incorporated herein by this reference.

### FIELD OF THE INVENTION

The invention relates, generally, to solid-profile filter media for use in water filtration. More specifically, the invention relates to solid profile filter media modules that optimize media utilization, and therefore, filter life, in a compact package/housing.

### SUMMARY OF THE INVENTION

The present invention comprises a filtration device, and/or methods of filtration using said device, that provides high quality of filtered liquid with a long and reliable filter life. The preferred embodiments of the invention comprise solid-profile filter media, or “filter blocks,” for installation in a filter housing that contains the filter blocks and controls inlet flow into the filter blocks and that controls outlet flow from the housing to a reservoir, carafe, tank, or downstream pipe/conduit.

In preferred embodiments, the invention comprises solid-profile filter media modules that optimize media utilization, and therefore, filter life, in a compact package/housing. Preferably, the compact package/housing is adapted to be installed, without tools, into a water dispenser, carafe, or other gravity-flow water filtration and dispensing unit, wherein the invented filter modules provide excellent filtration at desirable flow-rates even in a gravity-flow environment.

The solid-profile characteristic of the preferred modules means that the modules are each a self-supporting, rigid or substantially rigid, and porous block of filter media. The composition and position of the filtration media in the filter block is determined at the time of manufacture of the self-supporting filter block, so that the resulting filtration process may be much more consistent and predictable than is achieved with loose, granular media contained inside a housing. Granular media settles and/or shifts into unpredictable arrangements and positions, creating uneven and variable-thickness filter beds that have shortened and unpredictable filter lives (prior to breakthrough of contaminants). Also, loose activated carbon granules also tend to fragment and “dust” substantially more than the invented filter block modules, placing carbon particles into the filtered water.

The invented filter modules are preferably activated carbon, zeolitic, and/or other water filtration/treatment media granules/powders, with optional additives for optimizing capture of specific chemicals or metals, bound into a solid profile form by thermoplastic and/or other polymeric binders. Low melt index, or very low melt index, binders are preferred to maximize exposure of (and hence water access to) the activated carbon surface area.

Further, the filter module is preferably formed with substantially-consistently-thin walls surrounding the preferred single core/bore into the module. For example, the walls may be formed to be one or more thicknesses within a range of about 0.25-0.5 inch walls, with most of the walls being a single thickness. For example, greater than or equal to 90 percent of the filter wall may be a single thickness (with plus/minus 5 percent or less variation), and 10 percent or less of the wall may be thicker. See FIG. 2 for an example of modules having walls of substantially the same thickness. Therefore, most or substantially all of the filter media of the modules is used equally or substantially equally, filter life is maximized, and frequency of change-outs and/or breakthrough of contaminants are reduced.

In other embodiments, there is more difference in wall thickness, for example, greater than or equal to 60 percent of the filter wall may be a single thickness (with plus/minus 5 percent or less variation), and 40 percent or less of the wall may be thicker. See FIG. 6 for an example of modules having significantly different wall thickness, for example, thinner walls in approximately the top half of the module and thicker walls between the bottom end of the core/bore and the bottom surface of the module. Although such differences in wall thickness may result in greater flow through the thin wall portions than the thick wall portions, such embodiments may still be effective in many applications.

Preferably, multiple modules are installed in a housing, and liquid enters each of the modules by means of a single core/bore in the module. In many embodiments, the single core/bore extends into but not all the way through the module, and in some embodiments, the single core/bore extends all the way through the module but is closed/capped by a housing plate or other seal. Therefore, the liquid entering the single core/bore flows through the walls of each module, in multiple directions, to exit the module along all or substantially all of the outer surface of the module, so that the liquid flows out all around the circumference/outer perimeter of the module.

The modules are preferably spaced from each other inside the housing, by means of each module being attached or connected to a housing plate, wall, or other housing element, so that each module is fixed in place inside the housing for properly receiving inlet liquid flow and so that filtered water exits the module all around the module. This way, all or substantially all of the media is used generally equally in the filtration process, and filter life is maximized. The modules may be adhesively attached to said housing plate or wall, or attached by friction/interference fit, for example, with the media surface surrounding the inlet core/bore of the module being sealed to the housing so that liquid does not bypass the proper filtration path.

Multiple filter modules preferably are installed in the housing to be parallel and to extend axially parallel to the axial length of the housing. Each core/bore of the multiple modules preferably “faces” the same direction and the preferred housing plate, wall, or element to which the modules are attached serves both to hold the modules in place in the housing and to direct flow to each core/bore. Said plate may be substantially solid, but may have apertures at or near each core/bore to allow liquid to flow from the inlet end of the housing into each module.

These and other objects may be achieved by the preferred embodiments, as the invented filter modules lend themselves well to being manufactured for various uses, in various sizes, shapes, and styles, and of various filter media compositions. The invention is not limited to only the materials, structures, and methods of use disclosed herein, but other materials, structures, and methods will be apparent to one of skill after reading and viewing this disclosure.

### BRIEF DESCRIPTION OF THE DRAWINGS

Referring to the Figures, there are shown several, but not the only, embodiments of the invented filter modules and some, but not the only, embodiments of housings for use of the modules.

FIG. 1 is an exploded, top perspective view of one filter according to one embodiment of the invention, comprising a generally cylindrical filter housing containing two generally-D-shaped (half-cylinder) filter media modules.

FIG. 2 is an axial cross-sectional view of the filter of FIG. 1, with the cross-section plane taken along the line 2-2 in FIG. 3.

FIG. 3 is a top view of the filter of FIGS. 1 and 2.

FIG. 4 is an exploded, bottom perspective view of the filter of FIGS. 1-3.

FIG. 5 is an exploded, top perspective view of a filter according to another embodiment of the invention, comprising a generally cylindrical filter housing containing four generally-triangular-shaped filter media modules.

FIG. 6 is an axial cross-sectional view of the filter of FIG. 5, with the cross-section plane taken along the line 6-6 in FIG. 7.

FIG. 7 is a top view of the filter of FIGS. 5 and 6.

FIG. 8 is an exploded, bottom perspective view of the filter of FIGS. 5-7.

FIG. 9 is an exploded, top perspective view of a filter according to yet another embodiment of the invention, comprising a generally cylindrical filter housing containing four cylindrical/tubular filter media modules.

FIG. 10 is an axial cross-sectional view of the filter of FIG. 9, with the cross-section plane taken along the line 10-10 in FIG. 11.

FIG. 11 is a top view of the filter of FIGS. 9 and 10.

FIG. 12 is an exploded, bottom perspective view of the filter of FIGS. 9-11.

FIGS. 13-18 are various views of an alternative embodiment of a D-shaped filter module having a protruding three-sided rim on a front face of the module.

FIGS. 19-25 are various views of another alternative embodiment of a D-shaped filter module having a three-sided rim protruding from the front face plus an axial protruding rib.

FIGS. 26-32 are various views of another alternative embodiment of a D-shaped filter module similar to that of FIGS. 19-25, except that the axial protruding rib is shorter.

FIGS. 33-38 are various views of another alternative embodiment of a D-shaped filter module, with a rectangular protruding face surface portion.

FIGS. 39-44 are various views of the D-shaped filter modules of FIGS. 1-4, having a face surface that is flat and planar.

FIGS. 45-50 are various views of the triangular filter modules of FIGS. 5-8.

FIGS. 51 and 52 are views of a single-unit filter according to alternative embodiments of the invention.

FIGS. 53 and 54 are schematic examples of two different flowschemes that may be used with modules of the invention, wherein the filter shown is the filter type of FIGS. 51 and 52, but wherein said flowschemes will be understood to apply to other filter modules of this disclosure. FIG. 53 shows flow from the bores through the media wall to the outside of the filter block, and then out from the housing. FIG. 54 shows flow from outside the filter block, through the media wall and into the bores, then out from the housing.

### DETAILED DESCRIPTION OF THE PREFERRED EMBODIMENTS

Referring to the figures, there are shown several, but not the only, embodiments of the invented filters for liquid. Embodiments of the invention may be the modules for use in a filter housing and/or may be the assembly comprising the modules inside a housing that directs fluid flow into the modules and out of the housing. Alternative embodiments of the invention may include the assembly in gravity-flow water pitchers, carafes and/or other gravity-flow reservoirs.

Generally-cylindrical housings are preferred, as they tend to slide conveniently into and out of mating receptacle structure inside a pitcher, carafe and/or other gravity-flow reservoir. The preferred generally-cylindrical housing portrayed in the figures is slightly tapered inward from the top to the bottom, so that the top diameter is slightly larger than the bottom diameter of the sidewall of the housing cup. The housing shown in the Figures may be one embodiment of a frustrum-shaped (frustoconical) housing. Alternatively, other generally-cylindrical housings may be used, for example, exactly or nearly exactly a right-cylinder, or oval in radial cross-section. Also, alternatively, housings that are rectangular in radial cross-section may be useful in some embodiments.

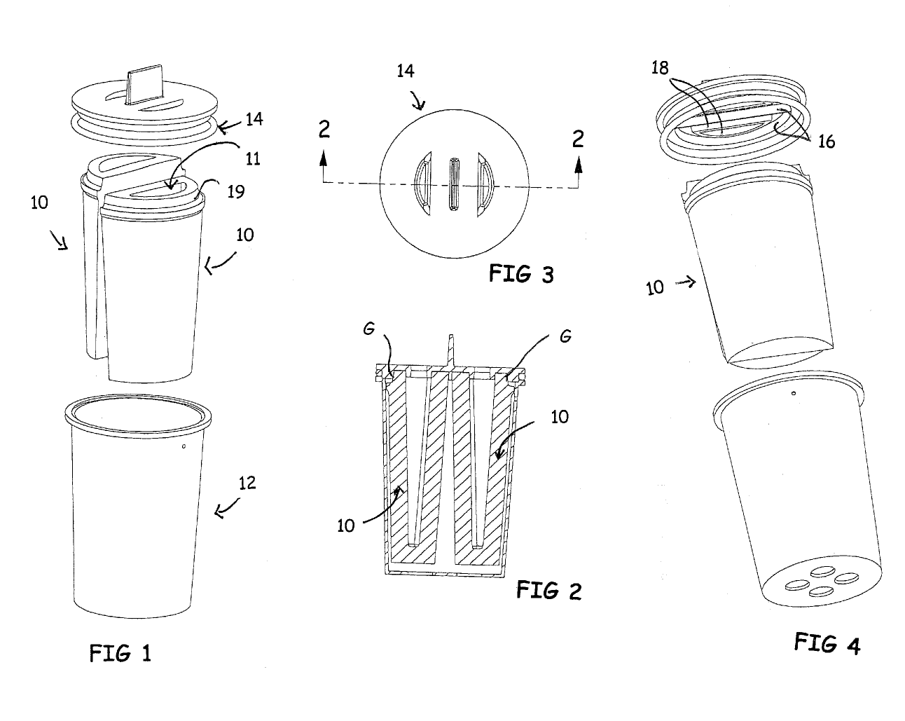

FIG. 1 is a side perspective view of one embodiment of the invention, a filter assembly, wherein two, generally-D-shaped filter modules 10 are provided in a generally cylindrical housing comprising a cup 12 and a lid 14. Each module 10 has a generally-D-shaped bore 11 from its top end toward its bottom end, preferably reaching to approximately ¼-½ inch from the bottom of the module. Thus, each bore 11 preferably does not extend all the way through its respective module 10, so that each module is closed at it bottom end by means of a wall of the same solid-profile filter media forming the rest of the module. In other words, the module bottom end is closed by the integral material of the module of the same composition as the rest of the module.

The D-shaped modules 10 of FIG. 4 are preferably adhesively or otherwise fixed and sealed (preferably at least at G), independently and separately, to the lid 14 of the housing, with the modules preferably being slightly separated (preferably 1/16-¼ inch) apart at their tops. The lid of the housing is preferably a top cover that encloses the housing interior space after the modules are installed, said lid preferably being a substantially-radial plate that mates with and is fixed to the upper edge of the housing cup, and that has apertures for allowing liquid into the filter and, particular, into the bores of the modules. Alternatively (not shown, but easily understandable from this disclosure and the drawings), the modules may be fixed to the housing lid so that they touch, preferably only along a small fraction of their axial lengths, for example, along ⅛- 1/32 of the axial length of the modules, at the facing surfaces of their top ends.

With the modules 10 fixed separately and spaced apart, water then can flow into the bore of each module, down axially and through the filter wall all around the D-shaped circumference of the module, and also out the bottom of the module. In the case of modules touching along a small fraction of their axial lengths, water can flow into the bore of each module, down axially and through the filter wall substantially all around the D-shaped circumference of the module (except perhaps not flowing out from the small fraction of surface area of the modules that touch), and also out the bottom of the module through the media wall that closes the bottom of the bore.

FIG. 2 illustrates an axial cross-section revealing the bores (11) of each of the D-shaped modules 10. The liquid, after exiting each module, can flow out of the bottom of the housing through exit holes/screen. See FIGS. 3 and 4 for additional details of this preferred filter assembly. The two D-shaped modules 10 provide excellent performance in a generally cylindrical housing, as water flow enters in two locations (one bore in each module) but flows through a large amount of filter wall (in many directions, including between the modules along all or substantially the entire length of each module), and, therefore, a very large amount of media surface area. The preferred modules allow solid-profile media to fill much of the interior volume of the housing, but with fixed and pre-formed liquid pathways being provided via the bore of each module, the spaces between the outer surfaces of the modules, and the spaces between the outer surfaces of the modules and the inner wall surfaces of the housing. This results in predictable and low-pressure drop liquid flow into, through, and from the media. Preferably, the filter modules are each made to comprise voids/interstitial spaces (porosity) that allow low-pressure-drop flow through the media with excellent contact between media and liquid.

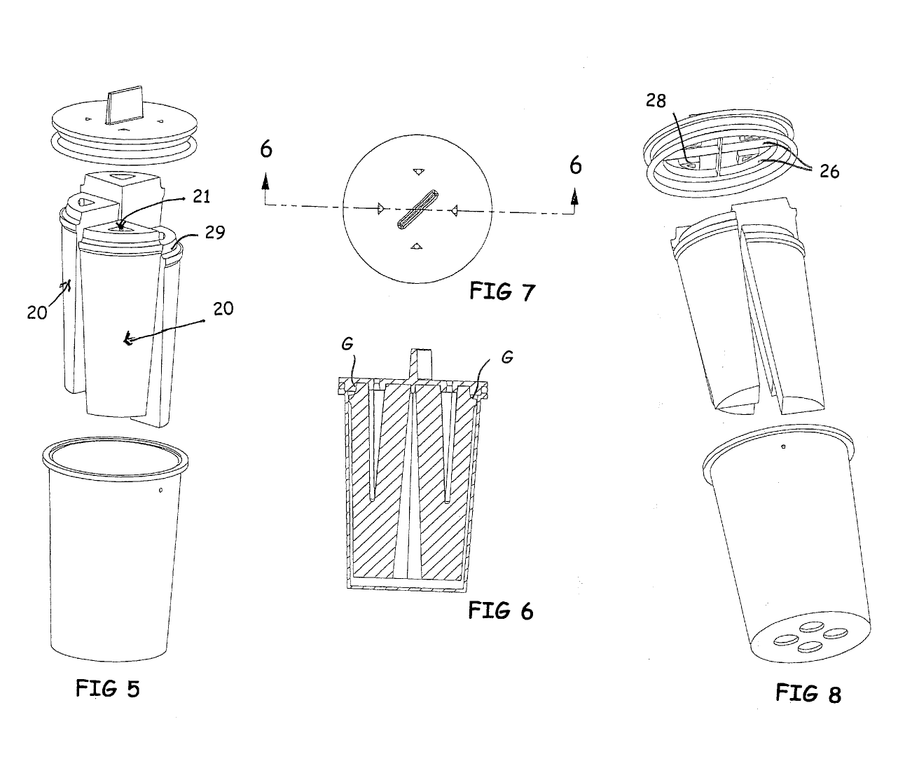

FIG. 5 is a perspective view of a filter (filter assembly) with an alternative set of modules 20 for a generally-cylindrical housing, wherein the modules 20 are adhesively or otherwise fixed and sealed (preferably at least at G), independently and separately, to the lid of the housing, with the modules 20 preferably being slightly separated from each other. Four, generally-triangularly-shaped filter modules are provided, wherein each one may be considered generally a “quarter” of a cylinder. Each module has a generally-triangular-(or quarter-cylindrical-) shaped bore 21 from its top end toward its bottom end, preferably reaching to approximately ¼-½ inch from the bottom of the module. The modules 20 are preferably closed at their bottom ends, preferably by a filter media wall of the same composition as the rest of the module. The four modules fit into the housing with their “points” facing each other at or near the central longitudinal axis of the filter. Note that, while the lid/plate portrayed is a major piece of the housing, in alternative embodiments, the plate may be an insert piece inside the internal cavity of the housing, and may be separate from the lid or cover of the housing.

The bore 21 of each of the generally-triangular modules will be generally triangular in shape, generally matching the outer surface shape of the modules. See details of these modules and housing in FIG. 5-8. As discussed above for the embodiment of FIGS. 1-4, the modules 20 of FIGS. 5-8 are preferably attached and sealed to the upper lid/plate of the housing, with the modules being slightly separately (preferably 1/16-¼ inch) apart at their tops. This way, water then can flow into the bore of each module, down axially and through the filter wall all around the triangular-shaped circumference/perimeter of the module, and also out the bottom of the module. The liquid, after exiting each module, can flow out of the bottom of the housing through exit holes/screen. These four modules provide excellent performance in a generally cylindrical housing, as water flow enter in four locations (one bore in each module) but flows through a large amount of filter wall (in many directions, including between the modules along all or substantially the entire length of each module), and, therefore, a very large amount of media surface area. The preferred modules allow solid-profile media to fill much of the interior volume of the housing, but with fixed and pre-formed liquid pathways being provided, via the bores, the spaces between the outer surfaces of the modules, and the spaces between the outer surfaces of the modules and the interior surface of the housing cup. This results in predictable and low-pressure drop liquid flow into, through, and from the media. Preferably, the filter modules are each formed to have voids/interstitial spaces (porosity) that allow low-pressure-drop flow through the media with excellent contact between media and liquid.

In alternative embodiments (not drawn in the figures, but understood from this document's disclosure and from FIGS. 5-8), three modules may be used, wherein each of the three modules is generally ⅓ of a cylinder. The bore into each module would be generally the same shape as the module's outer surface, so that the housing would be substantially filled with three, generally triangular modules (each 120 degrees of the whole 360 degrees) fixed to the lid/cover of the housing and featuring three generally triangular bores. Alternative embodiments may be other fractions of a cylinder, for example, ⅕ (about 75 degrees) or ⅙ (about 60 degrees) of a cylinder but ½, ⅓, or ¼ of a cylinder are preferred.

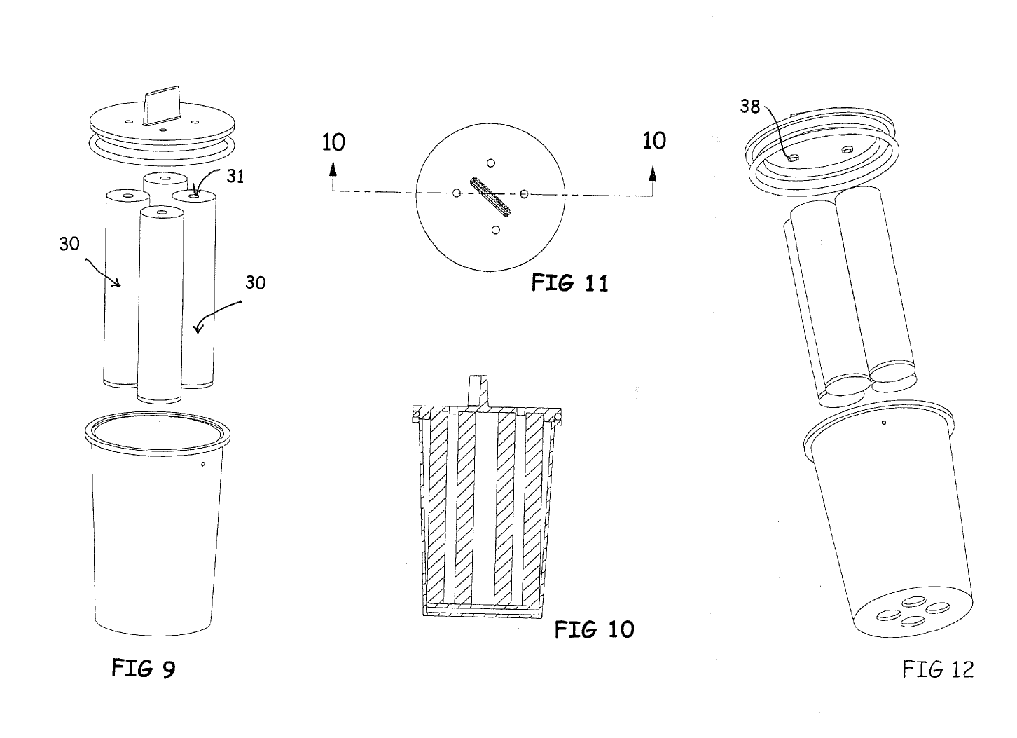

A third set of modules 30 shown in FIGS. 9-12. These modules 30 are tubular modules, which extend axially inside the housing parallel to the longitudinal axis of the filter. Each module has a generally cylindrical bore 31 from its top end toward its bottom end, preferably reaching to approximately ¼-½ inch from the bottom of the module. Each module 30 is closed at its bottom end either by a solid plate (having no apertures) or by a media wall of the same material as the rest of the module. The bore 31 of each of the cylindrical modules will be generally circular/cylindrical in shape, generally matching the outer surface shape of the modules. Because these modules do not conform to, and fill, the internal cavity of the housing to the extent of the other embodiments portrayed, these modules may not provide as much surface area and total mass of media as the other embodiments, but these modules may be more convenient to manufacture.

The four cylindrical modules 30 fit into the housing, adhesively or otherwise fixed to the lid/plate of the housing. As discussed above, the lid/plate may be a major piece of the housing, but, in alternative embodiments, the plate may be an insert piece inside the internal cavity of the housing, and may be separate from (underneath) the lid or cover of the housing. As discussed above, the modules are preferably adhesively or otherwise fixed, independently and separately, to the lid/plate of the housing, with the modules being slightly separately ( 1/16-¼ inch) apart at their tops. Water then can flow into the bore of each module, down axially and through the filter wall all around the circular circumference/perimeter of the module, and also out the bottom of the module. The liquid, after exiting each module, can flow out of the bottom of the housing through exit holes/screen.

One may see in the drawings, examples of lid structure that is adapted to connect to and/or seal with the upper ends of the modules for securing the modules to the lid and directing liquid into the bore of each module, thus retaining them in a secure and sealed relationship to the housing wherein flow is preferably partitioned equally to the multiple modules. For example, FIG. 4 illustrates depending D-shaped walls (the “outer D-walls” 16) into which the module fits so that its outer perimeter at its top is glued (G) to said outer D-walls. FIG. 4 also illustrates inner D-walls 18 that slide into and mate with the upper edge of the bore of each of the modules. This way, liquid flowing through the D-shaped apertures in the lid preferably splits in two to flow into the bores of the two modules. Adhesive, glue, or other securing and sealing material is preferably provided all around the groove (see groove 19 and glue G) provided in at least portions of the outer perimeter of the upper end of the modules, so that the modules are fixed to the outer D-walls and water flows into the bores and does not by-pass the modules. Adhesive, glue, or other securing/sealing material may optionally be provided on the inner-D-walls but is not preferred.

In FIG. 8, one may see the depending generally-triangular outer walls 26 on the underside of the lid that surround and help retain the upper, outer perimeter edge of each module. Also, one may see the depending generally-triangular inner walls 28 on the underside of the lid walls that slide into the bores of the modules. Adhesive, glue, or other securing and sealing material is preferably provided all around the groove (groove 29 and glue G) provided in at least portions of the outer perimeter of the upper end of the modules, so that the modules are fixed to the depending outer walls and water flows into the bores and does not by-pass the modules. Adhesive, glue, or other securing/sealing material may optionally be provided on the depending inner walls but is not preferred.

In FIG. 12, one may see the depending circular walls 38 on the underside of the lid that slide into the bores of the modules. In this embodiment, adhesive, glue or other securing and sealing material may be provided on the top end radial surfaces of each module, and so depending outer walls (to surround the upper end of each module) are not provided on the underside of the lid.

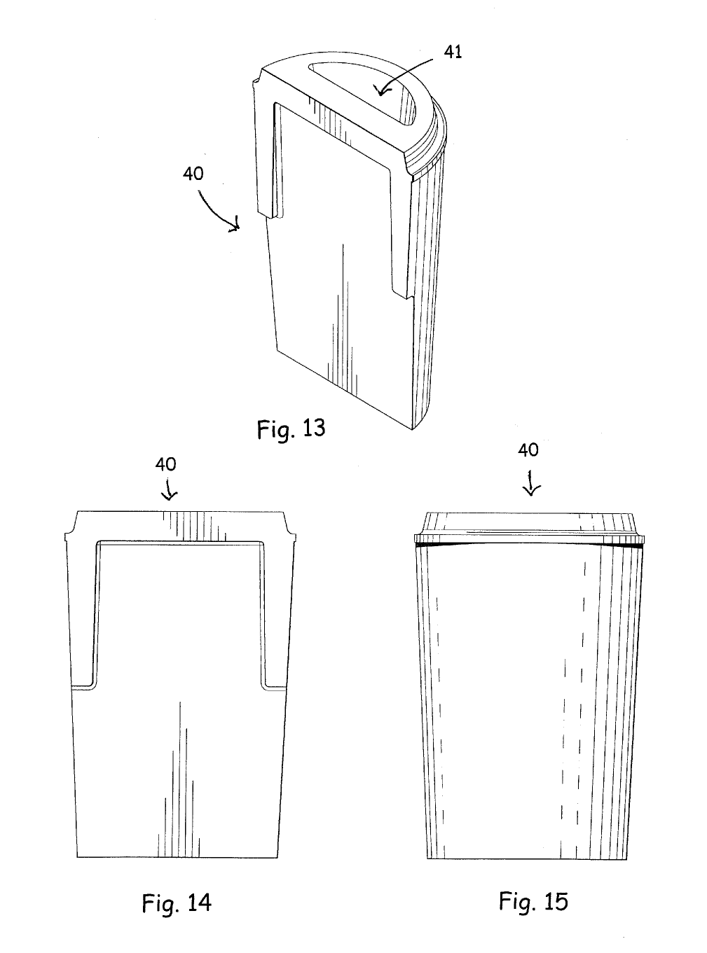

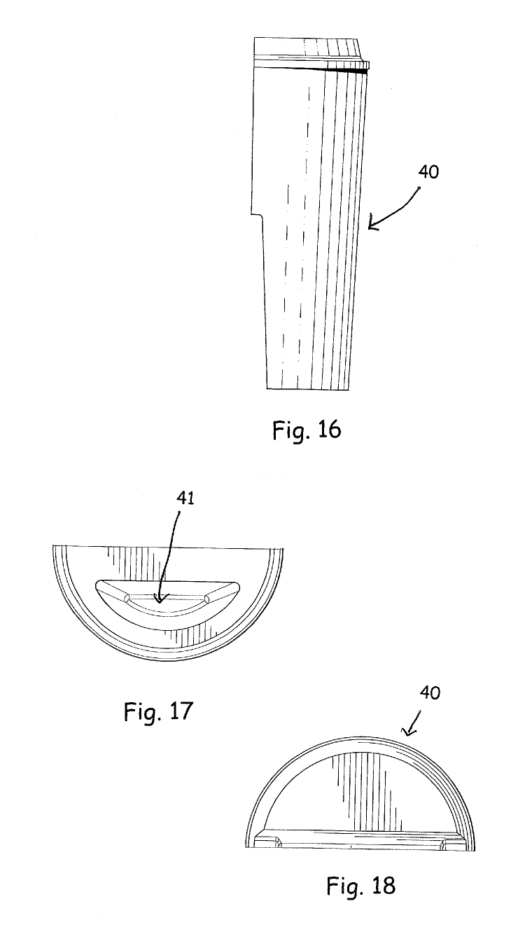

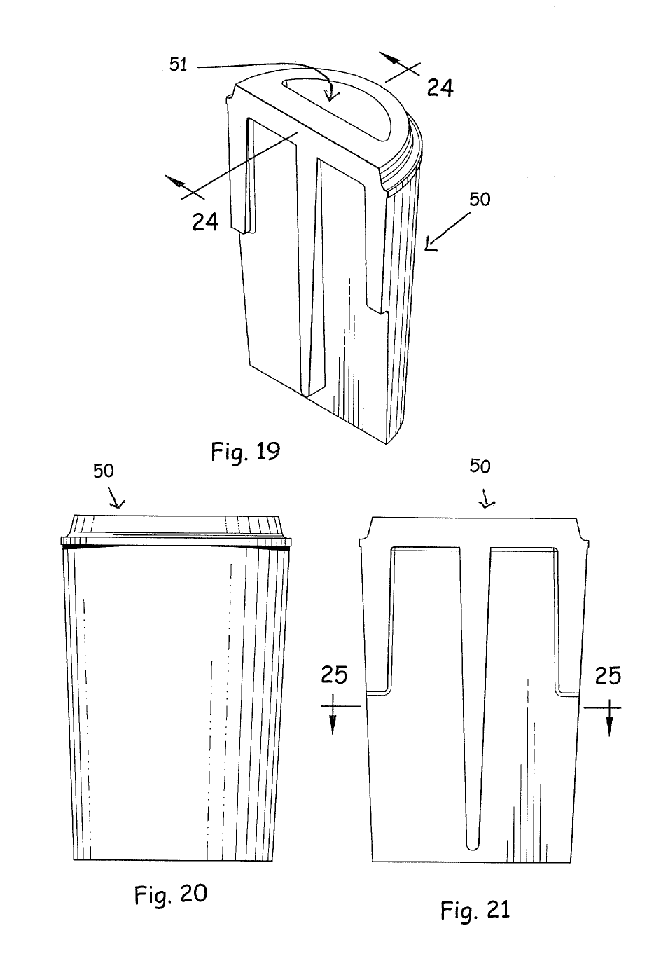

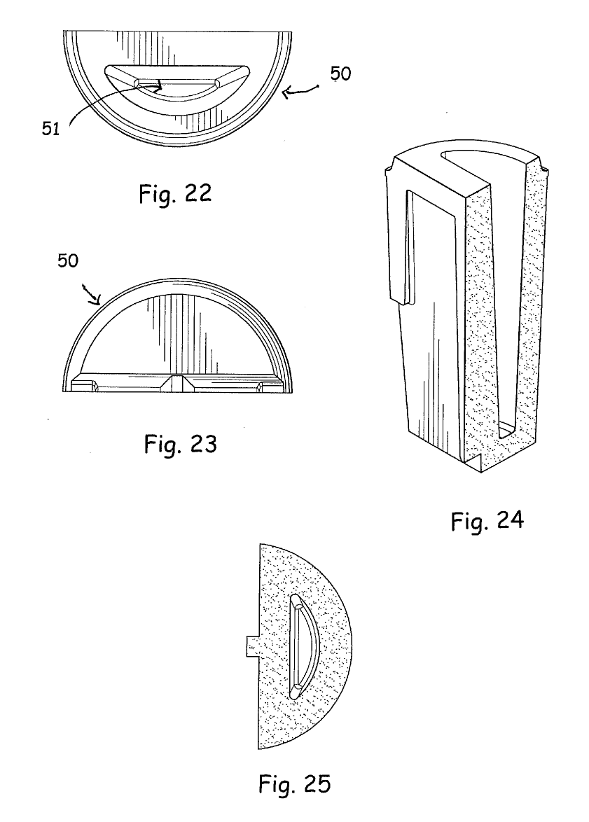

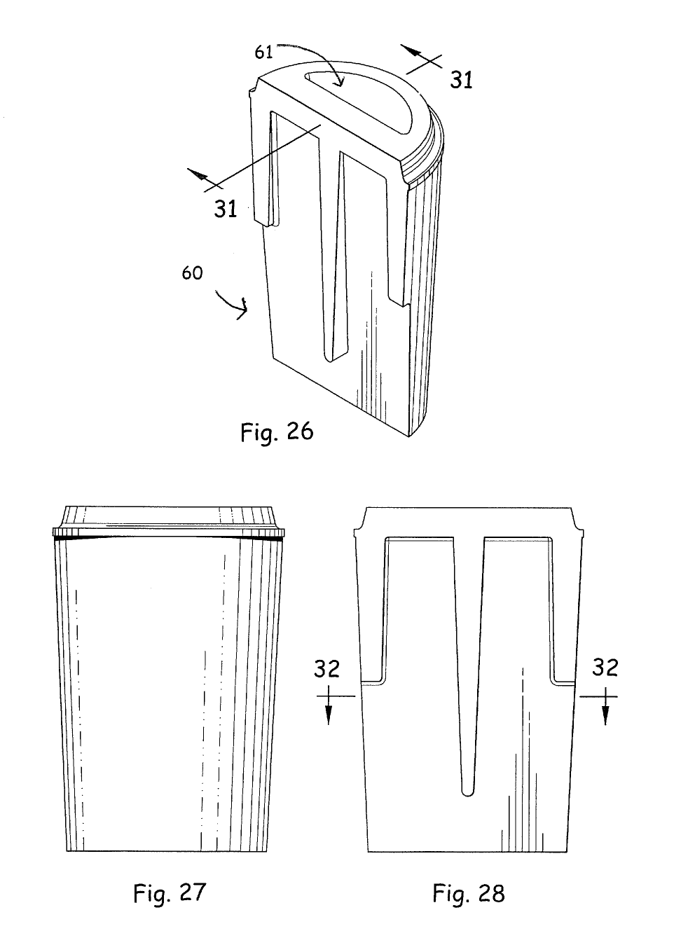

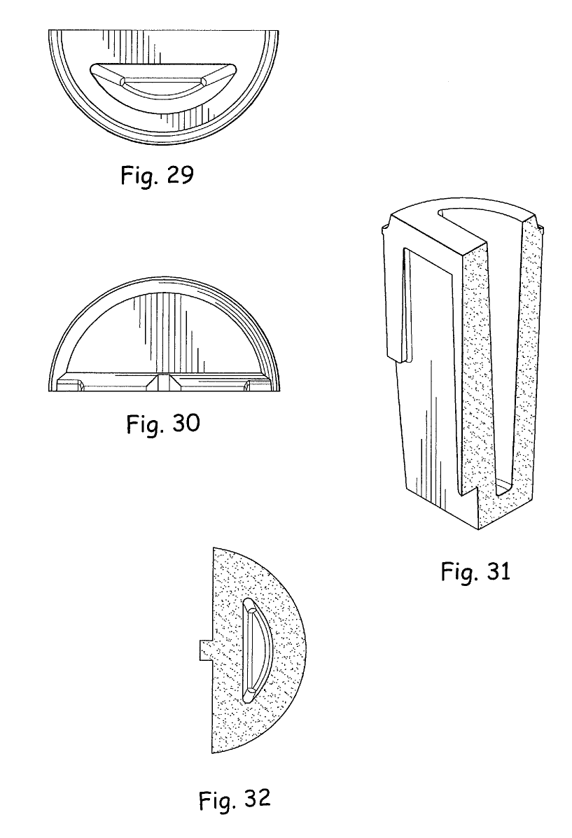

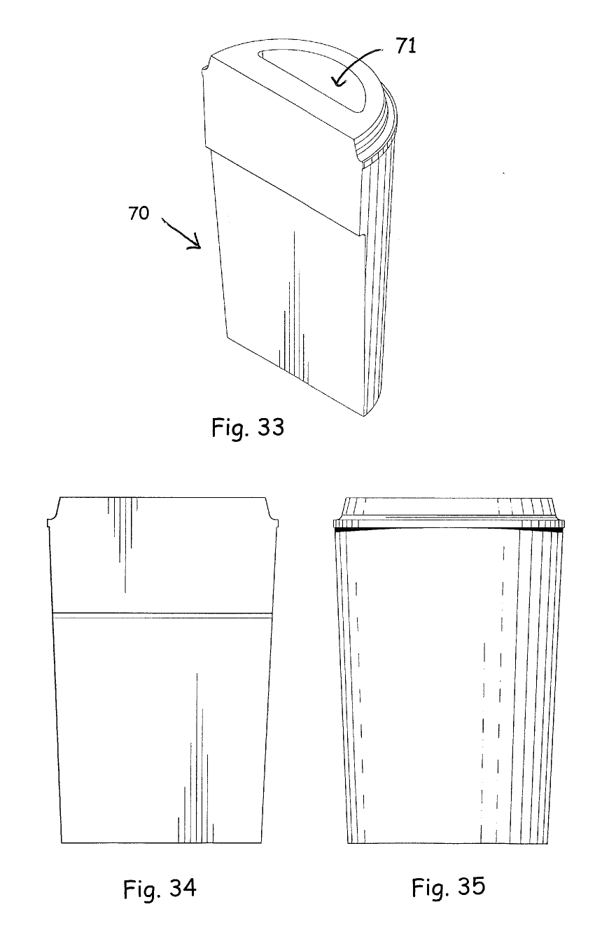

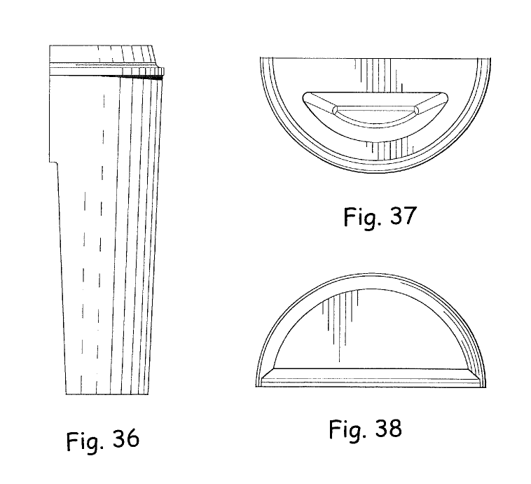

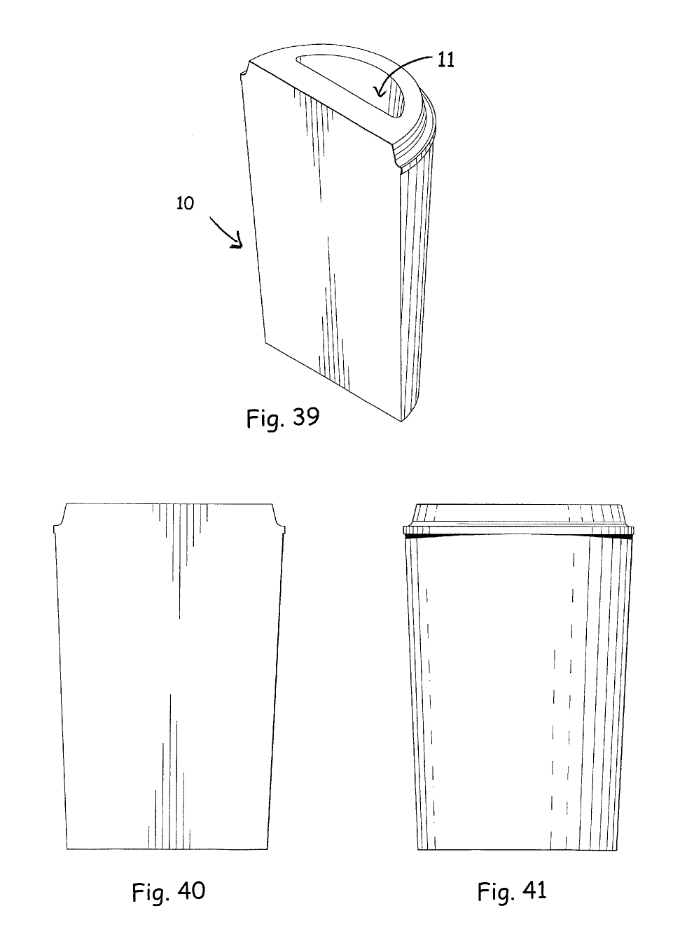

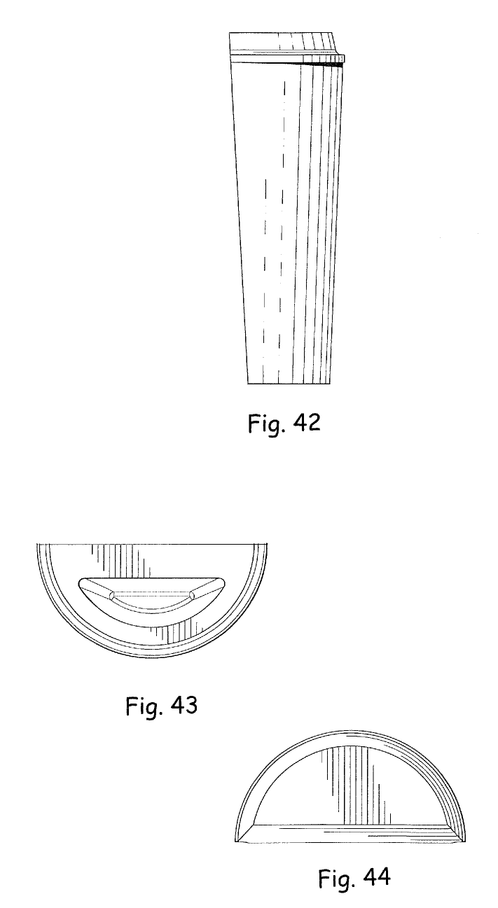

FIGS. 13-44 portray various D-shaped filter modules 40, 50, 60, and 70, and 10, that may be used to excellent advantage in generally cylindrical housings, especially in gravity-flow filter systems for drinking water. It will be understood from this disclosure that preferably two of the D-shaped modules will be provided in each generally-cylindrical housing. Note that FIGS. 39-44 show additional detail of the module 10 embodiment features in FIGS. 1-4. The bores of these various modules 40, 50, 60, 70 are called-out as 41, 51, 61, and 71, and the bore for module 10 is called out as 11.

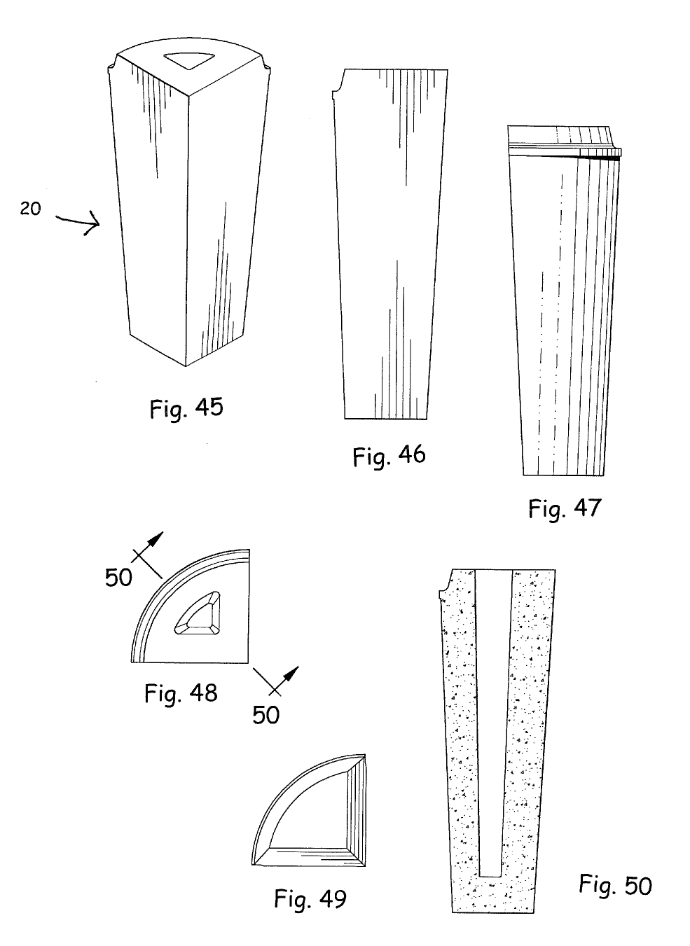

FIGS. 45-50 show additional detail of the generally-triangular modules 20 of FIGS. 5-8.

The inventors believe that there is room for improvement especially in filters used for gravity flow water filtration devices, such as water pitchers, carafes, and countertop tanks, and in the filters that are used for low-pressure systems (such as 30 psi or less). The inventors believe that embodiments of the invented solid profile filter block “modules” may be effective for said gravity flow or low-pressure systems, and/or for a wide variety of applications other than gravity-flow and low-pressure systems. Preferred embodiments of the invented apparatus and methods may satisfy the needs of many filtration applications and flow schemes by providing filters of improved flow distribution, flow rate, contaminant reduction/removal, performance consistency, and/or durability.

While the preferred embodiments of the invention comprises multiple filter block modules attached to a housing portion without the modules being directly connected to each other, alternative embodiments may include multiple or all of the modules in a given housing being also connected to each other. Such a connection of a module to at least one other module may be by adhesive, polymeric binder, melting and re-solidification of binder already present in said modules, and/or other direct attachment of a given module to another module. Direct attachment may also include clamping, engaging, or fastening a given module to another module by filter housing components, clamps, or fasteners.

As described above and as shown in the Figures, the multiple modules are preferably shaped and positioned so that space is provided between the “facing” surfaces of the modules. This provides space between exterior surfaces of said modules for fluid flow out of said modules (in the case of flow from the bore outward across the media walls) or into the modules (in the case of flow inward across the media walls into the bore). As discussed above, this way, all or substantially all of the filter media of each module is accessible to fluid for filtration, rather than solely the media near the outermost perimeter/circumference of the modules.

The preferred D-shaped and triangular-shaped are “clustered” around a central axis, with the modules being sized and shaped to fill substantially all (preferably greater than 70 percent, and more preferably greater than 80 percent) of the interior volume of the housing. The preferred filter block modules may be considered three-dimensional rather than sheet-like, plate-like, or generally two-dimensional. Also, the preferred filter block modules are of dimensions such that they are not to be considered “pleated” or “corrugated” sheets or plates. These “clustering,” “specially-sized-and-shaped,” and “three-dimensional” adaptations allow embodiments to achieve the objectives of a relatively large volume of media in a small “package” (small housing, and small “footprint” inside a water filtration pitcher or other device), with a low pressure drop, good flow distribution, coupled with durability and performance consistency.

The modules may be molded or formed in different molds, at different times, and/or by different processes, followed by attachment of the modules to the lid, cover, and/or other housing portions and/or to one or more adjacent filter block modules. The filter block modules of the preferred embodiments comprise activated carbon particles/granules, binder particles, and optional additives. The preferred optional additives are metals removal additives, for example, lead sorbent/scavengers such as Alusil™ or ATS™, or arsenic removal additives. Some embodiments of the invented filters may be effective in removing both soluble and/or particulate lead from water. Optionally, instead of or in addition to, carbon particles/granules, activated carbon fibers may be used with binder to form the solid profile. Also, other filtration or treatment media may be used, in place of or in addition to, activated carbon granules or fibers.

The opening of each bore may be located at or near a common first axial end, and the modules preferably extend from that common end generally parallel to each other, and preferably clustered around, or arranged symmetrically around, the center axis of the filter rather than on a single plane. In such embodiments, inlet or out fluid (depending on whether the application is an inside-out or an outside-in flow scheme) would enter or leave the multiple bores at the same or about the same time at or near the time of entering or exiting the filter.

It is preferred that there is symmetry along the flow path so that fluid entering the filter will be divided equally into a number of flow-portions equal to the number of modules. Also, it is preferred that each module in the filter be the same or substantially the same, for example, the same or similar amounts and types of media and the same size and shape, so that each of the flow-portions will be filtered/treated the same or very similarly to fluid entering others of the modules.

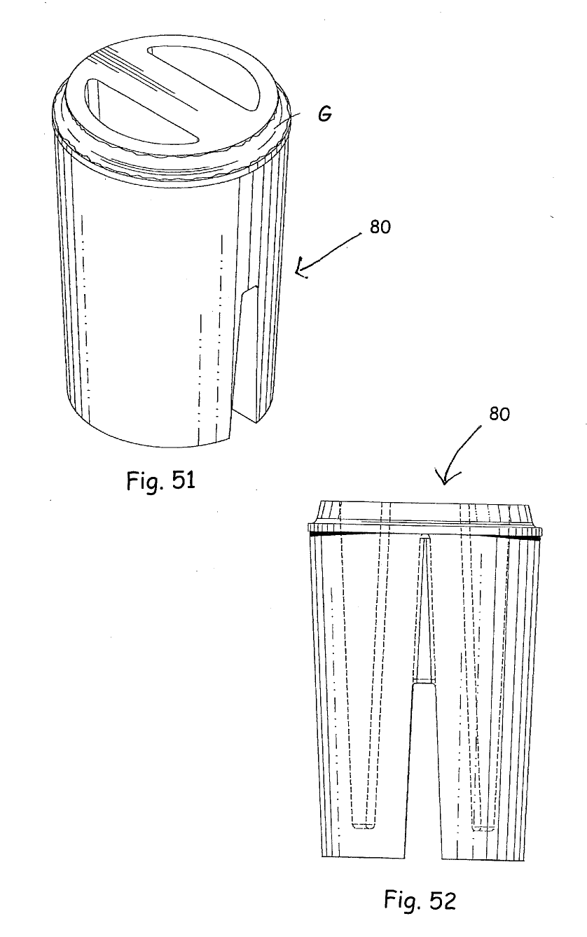

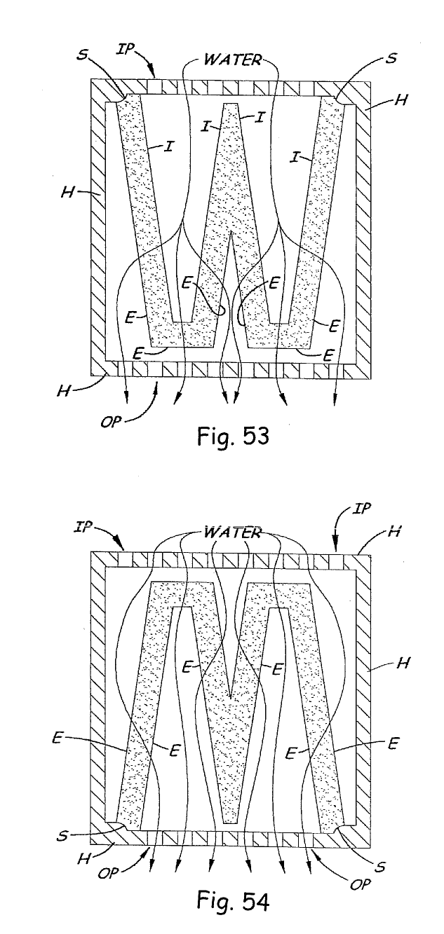

Alternative embodiments of the invention adapted for generally cylindrical housings comprise multiple of the shapes disclosed herein being bonded or formed together into a single, unitary filter block. Some of these alternative embodiments are disclosed in U.S. Non-Provisional Ser. No. 11/858,765, filed Sep. 20, 2007, and Provisional Application Ser. No. 60/846,162, filed Sep. 20, 2006. The present application claims priority of these two applications and the entire disclosure of these two applications is incorporated herein. FIGS. 51 and 52 illustrate some but not all of the embodiments of the single, unitary filter block 80 that may be used in generally cylindrical housings, and FIGS. 53 and 54 illustrate examples of fluid flow through such embodiments.

In FIGS. 53 and 54, the illustrated inside-out flow scheme and outside-out flow scheme, are for a filter block/modules provided in a filter cartridge housing H, and it will be understood from looking at the figures that the flow scheme would apply generally to a single, unitary filter block (as in FIGS. 51 and 52) or the separate modules described herein. The surfaces marked “I” are those that are considered portions of the internal surface of the filter block (or “the internal surface area” or “cavity surface area”). The surfaces marked “E” are those that are considered portions of the exterior surface of the filter block; note that this includes the surface of the indentation and it is in fluid communication with the other portions of the external surface. The surfaces marked “S” are those that are sealed against housing or other sealing structure to control fluid flow and prevent bypass. Note that the fluid inlet distribution and fluid outlet are schematically drawn, including many inlet holes “IP” and many outlet holes “OP,” as the inlet and outlet distributors/ports may be designed in various ways as will be understood by those of skill in the art.

Many, but not all, embodiments of the multiple-module sold profile filters use activated carbon and thermo-set binder, and the preferred proportions may range from about 5 up to about 70 weight percent binder, and 95 down to about 30 weight percent activated carbon plus additives. More preferably, many embodiments comprise 10-50 weight percent binder and 90 down to 50 weight percent activated carbon plus additives.

An especially preferred composition, for example, for gravity flow or low-pressure filter block modules according to embodiments of the inventions is: 30-50 wt-% binder(s), 28-52 wt-% powdered or granular activated carbon, and 18-22 wt-% lead removal media, wherein the total of the binder, activated carbon and lead removal media equals 100-%. Filter blocks have been made from about 40 wt-% binder (GUR 2122™), about 38 wt-% powdered activated carbon, and about 22 wt-% lead removal (Alusil™) media. Activated carbon size distribution such as the following was used: D10 of about 10-30 microns; D50 of about 70-100 microns; and D90 of about 170-200 microns. These blocks have been found to perform effectively in water filtration, including obtaining lead removal results that meet the recent NSF Standard 53 for lead in drinking water (less than 10 ppb lead, that is, less than 10 ppb total of soluble and particulate lead), while also achieving a flow rate of 1 liter per 4-7 minutes flow rate of water filtration, for example. It is noteworthy that a filter comprising multiple modules may provide this excellent performance with only about a 2 inch outer diameter and about a 3 inch axial length (for the total filter comprising two D-shaped modules), comprised only binder, activated carbon and lead sorbent in a solid profile, and did not contain any ion exchange resin or zeolite (which are conventionally used in gravity flow filters for metals removal). Such performance could result a filter, for a water carafe or other gravity flow apparatus, of overall dimensions of less than 3 inches in diameter and less than 5 inches in length, for example, meeting the recent NSF Standard 53 for lead removal. The inventors also believe that this performance may be achieved, with embodiments of the filter modules, over a long filter life.

In order to form the media components into the solid profile filter modules, a mixture of the media components and binder(s) may be placed in a mold(s), and may be compressed with a piston or weight on the mixture, for example, and heated to make the binder tacky enough to stick to the media particles, thus, holding them together in a solid profile when cooled. Typically, heating in a 400-500 degree F. oven for about 30 minutes will effectively heat the mixture to reach the desired amount of binder tackiness. The preferred, but optional, compression may take place before heating, during heating, and/or after heating. Compression that reduces the volume of the mixture about 10-20 percent is preferred, but this may vary and may extend to a greater range (for example, 10-40 percent) or lesser range of compression. The mixing of components may be done by various methods, with the preferred result being that the binder is interspersed between the other components for effective connection of the components in a solid profile.

Many binders may be used, for example, thermoplastic binder, thermo-set binder, polyolefins, polyethylene, polyvinyl halides, polyvinyl esters, polyvinyl ethers, polyvinyl sulfates, polyvinyl phosphates, polyvinyl amines, polyamides, polyimides, polyoxidiazoles, polytriazols, polycarbodiimides, polysulfones, polycarbonates, polyethers, polyarylene oxides, polyesters, polyarylates, phenol-formaldehyde resins, melamine-formaldehyde resins, formaldehydeureas, ethyl-vinyl acetate copolymers, co-polymers and block interpolymers thereof, and derivatives and combinations thereof.

In order to minimize the amount of carbon or carbon plus additive surface area covered/blocked by binder, preferred binders exhibit less than a 5 g/min melt index, and more preferably less than a 1 g/min melt index by ASTM D1238 or DIN 53735 at 190 degrees C. and 15 kilograms. Particularly preferred binders have a melt index (ASTM D1238 or DIN 53735 as above) of less than or equal to 0.1 g/min. Binders from these ranges, and especially from the less than 1 g/min melt index group and the less than or equal to 0.1 g/min melt index group, may be selected that become tacky enough to bind the media particles together in a solid profile, but that maintain a high percentage of the media particle surface area uncovered/unblocked and available for effective filtration. Further, the selected binders preferably leave many interstitial spaces/passages open in the solid profile modules to create the desired porosity; in other words, it is desirable to have the binder not completely fill the gaps between media particles. A high amount of porosity is desirable, and, when combined with the high amount of “bulk” surface area for the modules (bulk surface area meaning the exposed surfaces of the block/modules, including the cavities and preferably the indentations described above), the preferred embodiments are effective in delivering fluid to the media of the block/modules, effective in fluid flow through the porous block/modules, and effective in fluid flow out of the media in the block/modules.

Embodiments of the modules may be used in liquid filtration applications and also in air or other gaseous material filtration applications. While the filter modules in the drawings, and the terminology used herein, are shown or described in terms of “up” and “down,” the filters are not limited to the orientations drawn; various orientations, housings, internals, and flowschemes may be used, as will be understood by one of average skill after viewing this Description and the Drawings.

While preferred examples are given above, various other sizes and types of media components may be used, and the invention is not necessarily limited to filter blocks comprising activated carbon. Alternative media may be found that, because of its porosity and/or contamination removal attributes, may be used in the multiple modules of the invention, as a supplement or additive to, or instead of, activated carbon.

Although this invention has been described above and in the Figures with reference to particular means, materials and embodiments, it is to be understood that the invention is not limited to these disclosed particulars, but extends instead to all equivalents within the broad scope of the following claims.

1. A filter comprising multiple porous filter block modules and a housing, each of said modules comprising filter media walls surrounding and defining a bore for receiving fluid, and each of said modules being connected to a portion of said housing to retain and seal the bore in fluid communication with a fluid inlet of the housing;
each module having an internal surface defined by said bore and reachable by inlet fluid to be filtered, wherein fluid directed to the internal surface flows through said filter media walls for filtration and exits the module at external surfaces of the module;
wherein the filter is characterized by:
having only two of said modules, wherein each of said two modules has an axial length and a radial dimension perpendicular to said axial length, and each of said two modules is D-shaped in radial cross-section substantially all along the axial length of the module, and wherein said bore is D-shaped all along the axial length of the bore;
wherein each of the two modules is made of materials selected from the group consisting of activated carbon powder, activated carbon granules, lead removal additive, arsenic removal additive, and at least one binder, and said at least one binder has a melt index of less than or equal to 0.1 g/min melt index by ASTM D1238 or DIN 53735 at 190 degrees C. and 15 kilograms.

2. A filter as in claim 1 wherein the inlet fluid is water, and wherein said two modules remove lead from said water to a level less than 10 ppb total of soluble and particulate lead by means of said water flowing through said filter media walls under gravity-flow.

3. A filter as in claim 1, each of said modules being made only of said at least one binder, activated carbon, and lead removal media, wherein said activated carbon has a size distribution equal to D10 of 10-30 microns, D50 of 70-100 microns, and D90 of 170-200 microns.

4. A filter as in claim 1, wherein said two modules are provided in a generally-cylindrical housing cup and are fixed to a radial lid that covers a top end of said housing cup, the two modules being spaced apart in said housing all along their axial lengths.

5. A filter as in claim 4, wherein said lid comprises outer depending walls that surround an outer perimeter of a top end of each of said modules.

6. A filter as in claim 5, wherein said lid comprises inner depending walls that are received in said bore of each module.

7. A filter as in claim 6, wherein said outer surface of each of the two modules is tapered to be smaller at a bottom end than at a top end of each module.

8. A filter as in claim 4, wherein the modules are each made of 30-50 wt-% binder, 28-52 wt-% activated carbon, and 18-22 wt-% lead removal media, wherein the total of said binder, activated carbon, and lead removal media is 100 wt-% of each filter module.

9. A filter block as in claim 8, wherein said binder is selected from the group consisting of: thermoplastic binder, thereto-set binder, polyolefins, polyethylene, polyvinyl halides, polyvinyl esters, polyvinyl ethers, polyvinyl sulfates, polyvinyl phosphates, polyvinyl amines, polyamides, polyimides, polyoxidiazoles, polytriazols, polycarbodiimides, polysulfones, polycarbonates, polyethers, polyarylene oxides, polyesters, polyarylates, phenol-formaldehyde resins, melamine-formaldehyde resins, formaldehydeureas, ethyl-vinyl acetate copolymers, co-polymers and block interpolymers thereof, and derivatives and combinations thereof.

10. A method of gravity-flow water filtration comprising:
providing a filter comprising a housing and multiple porous filter block modules inside said housing, each of said modules comprising filter media walls surrounding and defining a bore in each of said modules for receiving fluid, and said modules being connected to a lid of said housing, wherein the filter is characterized by:
comprising only two of said modules, wherein each of said two modules has an axial length and a radial dimension perpendicular to said axial length, each bore of each module is D-shaped in radial cross-section, each module outer surface is D-shaped in radial cross-section, and the modules are spaced apart so that they are adapted to allow fluid flow between them;
the filter modules being made of materials selected from the group consisting of activated carbon powder, activated carbon granules, lead removal additive, arsenic removal additive, and at least one binder, and said at least one binder has a melt index of less than or equal to 0.1 g/min melt index by ASTM D1238 or DIN 53735 at 190 degrees C. and 15 kilograms; and
the method is further characterized by:
directing water to the bores of the two modules so that the water flows through said filter media walls only under gravity flow to exit the filter modules at external surfaces of said modules; and
wherein said gravity flow of the water through the filer media walls removes lead from said water to a level less than 10 ppb total of soluble and particulate lead.

11. A method as in claim 10, wherein the modules are made only of said at least one binder, activated carbon, and lead removal media, wherein said activated carbon has a size distribution equal to D10 of 10-30 microns, D50 of 70-100 microns, and D90 of 170-200 microns.

12. A method as in claim 11, wherein at least one of said modules further comprises an elongated, axially-extending rib-brace between the two D-shaped modules.

13. A method as in claim 12, wherein:
the bores of the two modules extend generally parallel to each other, and said rib-brace also extends generally parallel to the bores;
the outer surface of each of the two modules is tapered to be smaller at a bottom end than at a top end of each module, and wherein said rib-brace is tapered to be smaller at its bottom end than at its top end, and the internal surface formed by said bores are tapered so that each bore has an overall smaller diameter at the bottom of the bore compared to the top of the bore.

14. A method as in claim 13, wherein each module is made of 30-50 wt-% binder, 28-52 wt-% activated carbon, and 18-22 wt-% lead removal media, wherein the total of said binder, activated carbon, and lead removal media is 100 wt-% of each module.

15. A filter comprising multiple porous filter block modules and a housing, each of said modules comprising filter media walls surrounding and defining a bore for receiving fluid, and each of said modules being connected to a portion of said housing to retain and seal the bore in fluid communication with a fluid inlet of the housing;
each module having an internal surface defined by said bore and reachable by inlet fluid to be filtered, wherein fluid directed to the internal surface flows through said filter media walls for filtration and exits the module at external surfaces of the module;
wherein the filter is characterized by:
having only four of said modules, wherein each of said four modules has an axial length and a generally triangular in radial cross-section substantially all along the axial length of the module, and wherein said bore is generally triangular all along the axial length of the bore;
wherein each of the four modules is made of materials selected from the group consisting of activated carbon powder, activated carbon granules, lead removal additive, arsenic removal additive, and at least one binder, and said at least one binder has a melt index of less than or equal to 0.1 g/min melt index by ASTM D1238 or DIN 53735 at 190 degrees C. and 15 kilograms.

16. A filter as in claim 15 wherein the inlet fluid is water, and wherein said four modules remove lead from said water to a level less than 10 ppb total of soluble and particulate lead by means of said water flowing through said filter media walls under gravity-flow.

17. A filter as in claim 15, wherein the modules are made only of said at least one binder, activated carbon, and lead removal media, wherein said activated carbon has a size distribution equal to D10 of 10-30 microns, D50 of 70-100 microns, and D90 of 170-200 microns.

18. A filter as in claim 15, wherein said four modules are provided in a generally-cylindrical housing cup and are fixed to a radial lid that covers a top end of said housing cup, the four modules being spaced apart in said housing all along their axial lengths.

19. A filter as in claim 18, wherein said lid comprises outer depending walls that surround an outer perimeter of a top end of each of said modules.

20. A filter as in claim 19, wherein said lid comprises inner depending walls that are received in said bore of each module.

21. A filter as in claim 20, wherein said outer surface of each of the four modules is tapered to be smaller at a bottom end than at a top end of each module.

22. A filter as in claim 18, said modules being made of 30-50 wt-% binder, 28-52 wt-% activated carbon, and 18-22 wt-% lead removal media, wherein the total of said binder, activated carbon, and lead removal media is 100 wt-% of each module.

23. A filter block as in claim 22, wherein said binder is selected from the group consisting of: thermoplastic binder, thermo-set binder, polyolefins, polyethylene, polyvinyl halides, polyvinyl esters, polyvinyl ethers, polyvinyl sulfates, polyvinyl phosphates, polyvinyl amines, polyamides, polyimides, polyoxidiazoles, polytriazols, polycarbodiimides, polysulfones, polycarbonates, polyethers, polyarylene oxides, polyesters, polyarylates, phenol-formaldehyde resins, melamine-formaldehyde resins, formaldehydeureas, ethyl-vinyl acetate copolymers, co-polymers and block interpolymers thereof, and derivatives and combinations thereof.
